(19) United States
(12) Patent Application Publication
(10) Pub. No.: US 2009/0087593 A1
(43) Pub. Date: Apr. 2, 2009

(54) ANTISTATIC OPTICAL FILM, POLARIZING PLATE, IMAGE DISPLAY, AND LIQUID CRYSTAL DISPLAY

(76) Inventors: Shunichi KONDO, Minami-Ashigara-shi (JP); Katsumi INOUE, Minami-Ashigara-shi (JP)

Correspondence Address: BIRCH STEWART KOLASCH & BIRCH, PO BOX 747, FALLS CHURCH, VA, 22040-0747, US

(21) Appl. No.: 12/238,158

(22) Filed: Sep. 25, 2008

(30) Foreign Application Priority Data
Sep. 26, 2007 (JP) P2007-249709

(51) Int. Cl. C09K 19/02; C08K 3/16; B32B 9/00

(52) U.S. Cl. 428/1.31; 524/413; 428/689

(57) ABSTRACT

An antistatic optical film includes a support; and an antistatic layer provided at least on one side of the support, wherein the antistatic layer is a layer formed by coating a solution containing a compound semiconductor, a solvent capable of dissolving the compound semiconductor, and a binder soluble in the solvent; and drying the solution.

### BACKGROUND OF THE INVENTION

1. Field of the Invention

The present invention relates to an antistatic optical film, a polarizing plate, an image display, and a liquid crystal display which are excellent in an antistatic effect, optical characteristics, durability and appearance, capable of manufacturing inexpensively and easily, and excellent in productivity.

2. Description of the Related Art

Liquid crystal display (LCD) necessitates the arrangement of polarizing elements on both sides of a liquid crystal cell from the image-forming method, and generally a polarizing plate is adhered. For the purpose of improving display grade, various optical films, such as a phase difference plate for prevention of coloration, a visual field-widening film for improvement of a viewing angle, a luminance-improving film for increasing contrast, and an antireflection film for preventing reflection and mirroring of outer lights are used in a liquid crystal panel, besides polarizing plates. The optical film is a general term for these films.

Surface protective films are generally stuck on the surfaces of these optical films for preventing the surfaces of the optical films from being scratched or soiled during transportation or manufacturing process. These surface protective films are peeled off after optical films are stuck on LCD and the like, and there are cases where the same or different surface protective films are again stuck after being peeled. Of these works, since electrostatic charge due to peeling occurs in the process of peeling the surface protective film, there are problems of the generation of breakdown of an LCD panel and the like and adhesion of dusts by the static electricity. After completion of a panel, in wiping the soil on the surface of the optical film (generally an antireflection film) on the visible side (upper side) with a piece of cloth, there are cases where problems such as adhesion of dusts and disorder of images arise, and with the optical film on the incident side (lower side), electrification is caused due to contact with the diffused film, which causes disorder of images.

Particularly in the case of LCD driven by an IPS system, a cell substrate of one side of a liquid crystal cell is generally treated with ITO, but the opposite side is not subjected to antistatic treatment. Therefore, with the optical film stuck on the surface of the side of the cell substrate not subjected to ITO treatment, electrostatic charge due to peeling is caused in peeling the surface protective film, and disorder of images sometimes occurs. Also in the case of LCD driven by a VA system, when a cell substrate subjected to ITO treatment is used on one side of a liquid crystal cell, there are cases where similar disorder of an image occurs.

For solving these problems, there are disclosed a polarizing plate having an antistatic film obtained by forming an antistatic film on the surface of a polarizing plate (in JP-A-2-73307 (The term “JP-A” as used herein refers to an “unexamined published Japanese patent application”.)), a polarizing plate comprising a polarizing film having provided on one side or both sides thereof a transparent conductive layer (in JP-A-4-124601 and JP-A-2004-338379), and an antireflection film of multilayer constitution comprising a substrate film having provided on one side or both sides thereof at least one transparent conductive layer (in JP-A-10-206603 and JP-A-2001-264503).

For forming antistatic performance on the surface of an optical film, a method of forming an antistatic layer by coating a layer-forming resin solution on the surface of the optical film and drying has been conventionally used. The techniques disclosed in JP-A-2-73307, JP-A-2004-338379 JP-A-10-206603 and JP-A-2001-264503 are also methods of forming an antistatic layer as the surface of a polarizing plate or as one layer of an optical film by coating an antistatic coating solution or a coating agent blended with an antistatic agent.

However, there are various problems in these techniques, such that 1) a polarizing plate decomposes or deteriorates due to an organic solvent in a coating agent, 2) since sufficient conductivity cannot be obtained, antistatic effect is insufficient, 3) adhesion failure occurs between the antistatic layer and the contiguous layer, and 4) the antistatic layer formed is liable to be scratched due to membranous weakness, so that the improvements of problems 1) to 4) are desired. Further, for increasing the transparency of coated film, metal particles (e.g., gold, platinum, silver, etc.), fine particles of metal oxide (e.g., ITO, ATO, AZO, GZO, PTO, FTO, etc.), and particles of organic conductive polymer have to be homogeneously dispersed in a dispersion solvent in finely dispersed state in forming a conductive coating solution, so that processes are complicated and the manufacture is costly.

The technique of JP-A-4-124601 forms a transparent conductive layer by using materials such as tin oxide, indium oxide, gold or silver according to a vacuum deposition method, a sputtering method or an ion plating method, but manufactures by these methods cost a lot, and productivity is low as compared with coating methods.

On the other hand, as a manufacturing method of a conductive film not relatively complicated and of few production problems, a method of providing an under layer on a support, and coating a solution of a compound semiconductor on the under layer to form fine particles of the compound semiconductor near the surface of the under layer in high concentration is disclosed (in JP-B-48-9984 (the term “JP-B” as used herein refers to an “examined Japanese patent publication”)), and relatively high conductivity is obtained. However, since the under layer is necessary for giving conductivity, and light transmission of the film is low, improvements are required for the optical film use.

### SUMMARY OF THE INVENTION

An aspect of the invention is to provide an antistatic optical film having laminated an antistatic layer at least on one side thereof, which film is excellent in antistatic effect, optical characteristics, durability and appearance, capable of manufacturing inexpensively and easily, and excellent in productivity. Another aspect is to provide an image display using the antistatic optical film.

As a result of eager examinations to solve the above problems, the present inventors have found that an antistatic layer can be produced very conveniently with a solution of a compound semiconductor, thus the above aspects can be achieved, and the invention can be attained.

That is, the invention consists of the following constitutions.

What is claimed is:
[1] An antistatic optical film comprising:
a support; and
an antistatic layer provided at least on one side of the support, wherein
the antistatic layer is a layer formed by coating a solution containing a compound semiconductor, a solvent capable of dissolving the compound semiconductor, and a binder soluble in the solvent; and drying the solution.
[2] The antistatic optical film of [1], wherein
the compound semiconductor is cuprous halide.
[3] The antistatic optical film of [1], wherein
the binder is a curable resin.
[4] The antistatic optical film of [1], wherein
the antistatic layer has a surface resistance of 10¹⁰ Ω/□ or less, and has a transmittance of all the rays of light of 85% or more.
[5] The antistatic optical film of [1], further comprising:
an adhesive layer.
[6] The antistatic optical film of [1], further comprising:
an antireflection layer.
[7] A polarizing plate comprising:
a polarizing film; and
protective films provided on both sides of the polarizing film, wherein
at least one of the protective films is the antistatic optical film of [1].
[8] An image display comprising:
the antistatic optical film of [1].
[9] An image display comprising:
the polarizing plate of [7].
[10] A liquid crystal display comprising:
an IPS mode or VA mode liquid crystal cell; and
the antistatic optical film of [1].
[11] A liquid crystal display comprising:
an IPS mode or VA mode liquid crystal cell; and
the polarizing plate of [7].

### DETAILED DESCRIPTION OF THE INVENTION

The invention will be described in further detail below, but the invention is not restricted thereto.

The antistatic optical film of the invention is an antistatic optical film comprising a support having an antistatic layer at least on one side of the support, and the antistatic layer is a layer formed by coating a solution containing a compound semiconductor, a solvent capable of dissolving the compound semiconductor, and a binder soluble in the solvent, and drying.

### Antistatic Layer:

The antistatic layer that is an essential constituent layer of the antistatic optical film of the invention is a layer formed by coating a solution containing a compound semiconductor, a solvent and a binder, and drying.

### Compound Semiconductor:

The compound semiconductor for use in the antistatic layer that is an essential constituent layer in the antistatic optical film of the invention is a semiconductor comprising two or more atoms bonded by ionic bond, and the volume resistivity at room temperature is 10⁸ Ω·cm or less.

As the materials of the compound semiconductor, halides of metals selected from bismuth, gold, silver, copper, indium, iridium, lead, nickel, palladium, rhenium, tin, tellurium, and tungsten; cuprous thiocyanate, cupric thiocyanate, silver thiocyanate, and iodomercurate can be exemplified. In the invention, cuprous halide and silver halide are preferred, cuprous iodide and silver iodide are more preferred, and cuprous iodide is most preferred from economical point.

The shape of the compound semiconductor is preferably a fine particle shape. The average particle size is not especially restricted, but is preferably from 10 nm to 1 μm, more preferably from 20 nm to 300 nm, and still more preferably from 20 nm to 200 nm.

### Solubilizer:

Since the compound semiconductor is not easily soluble in water and many organic solvents, a complex compound capable of forming a soluble complex salt with the compound semiconductor can be used as the solubilizer.

As the complex compounds, alkyl metal halides such as lithium iodide and sodium iodide, and ammonium halides can be generally used as the complex compounds of compound semiconductors that are halides such as silver halide, cuprous halide, stannous halide, and lead halide. Complex salts formed with these complex compounds are easily soluble in the later-described volatile ketone solvents. In general, since the complex compound remains in semiconductor fine particles present in an antistatic layer formed by coating the later-described solution and drying to remove the solvent, it is preferred to wash the antistatic layer with water to remove the complex compound. However, a complex salt itself shows sufficient conductivity according to cases. In such a case, the complex salt itself can also be used as a compound semiconductor.

### Solvent:

As the solvents capable of dissolving the compound semiconductors, volatile ketone solvents are preferably used. Specifically, acetone, methyl ethyl ketone, 2-pentanone, 3-pentanone, 2-hexane, 2-heptanone, 4-heptanone, methyl isopropyl ketone, ethyl isopropyl ketone, diisopropyl ketone, methyl isobutyl ketone, methyl-t-butyl ketone, diacetyl, acetylacetone, acetonylacetone, diacetone alcohol, mesityl oxide, chloroacetone, cyclopentanone, cyclohexanone, and acetophenone can be exemplified. These solvents may be used by one kind alone, or as a mixture in an arbitrary mixing ratio.

When lithium iodide or sodium iodide is used as the complex compound, solvents other than the above ketone solvents can be used as the solvents for solving the complex salts. For example, methyl acetate, ethyl acetate, n-propyl acetate, isoamyl acetate, isopropyl acetate, n-butyl acetate, tetrahydrofuran, dimethyl-formamide, methyl cellosolve, and methyl cellosolve acetate can be effectively used.

When cuprous iodide is used as the compound semiconductor, since the cuprous iodide forms a complex salt with acetonitrile of a solvent and dissolves in the acelonitrile, it is preferred to use acetonitrile as the solvent. Therefore, it is possible to form fine particles of cuprous iodide in the antistatic layer without leaving a complex compound by coating and drying. From this point cuprous iodide is preferred as the forming material of the compound semiconductor.

### Binder:

As the binders to be used together with a compound semiconductor in the invention, known resins in a wide range can be used so long as they are resins having film-forming ability and soluble in a solvent for dissolving a compound semiconductor For example, vinyl acetate resins, vinyl chloride-vinyl acetate resins, vinyl acetate-methyl methacrylate copolymers, methyl methacrylate-methacrylic acid copolymers, and cellulose acetate butyrate can be exemplified, but the invention is not restricted thereto.

As the binders, curable resins that form cured resins capable of fixing semiconductor fine particles are usefully used. As curable resins, known monomers, prepolymers and crosslinking agents in a wide range can be used so long as they are curable resins soluble in a solvent for dissolving a compound semiconductor, and capable of forming a film by treatment during coating or after coating (heating, light irradiation, chemical reaction and the like).

As the curable resins, for example, the compounds described in Kakyo-zai Handbook (Handbook of Crosslinking Agents), Taiseisha Ltd. (1981), Saishin UV Koka Jitsuyo Benran (The Handbook of the Latest Practical UV Curing), Technical Information Institute Co., Ltd. (2005), and UV and EB Koka Gijutsu no Genjou to Tenbo (The Present Situation and a View of UV and EB Curing Techniques), CMC Publishing Co., Ltd. (2002) can be used. The specific examples include isocyanate group-containing compounds, such as polymethylene polyphenyl isocyanate, adducts of tolylene diisocyanate and trimethylolpropane, and adducts of xylene diisocyanate and trimethylolpropane, compounds having an epoxy group such as reaction products of aliphatic diol and epichlorohydrin, and reaction products of bisphenol A and epichlorohydrin, compounds having a melamine structure, combinations of a monomer, an oligomer, or a polymer having polyfunctional polymerizable groups (an acryloyl group, a vinyl ether group, an epoxy group, an oxetane group, etc.) such as pentaerythritol tetraacrylate and thermal polymerization initiators, combinations of a monomer, an oligomer, or a polymer having polyfunctional polymerizable groups and photo-polymerization initiators such as “Irgacure 907” (manufactured by Ciba Geigy Japan Limited), and compounds that are hardened by hydrolysis and condensation reaction of metal alkoxides. It is also possible to use commercially available products, such as “Coronate L” (a trade name, manufactured by Nippon Polyurethane Industry Co., Ltd.), epoxy resin “Epicote 828” (a trade name, manufactured by Shell), “Vinyl Acetate Resin C-5” (a trade name, manufactured by Sekisui Chemical Co., Ltd.), and “Millionate MR-100” (a trade name, manufactured by Nippon Polyurethane Industry Co., Ltd.)

### Blending Proportion:

It is preferred to use a compound semiconductor in concentration in a solution of from 0.1 to 50 mass %.

A binder is used in the proportion of preferably from 3 to 200 mass parts per 100 mass parts of the compound semiconductor, more preferably from 5 to 100 mass parts, and most preferably from 10 to 50 mass parts. When a binder is short in use amount, the fixation of the compound semiconductor is insufficient, crystallization occurs with the lapse of time, and clouding is caused in the film, while when the amount of a binder is too much, conductivity is liable to lower, so that the amount is preferably in the above range.

When a complex compound is used as a solubilizer, the use amount is preferably from 10 to 1,000 mass parts per 100 mass parts of the compound semiconductor, and more preferably from 50 to 500 mass parts.

The solution is preferably coated so as to reach the dry coating mass of from 5 to 2,000 mg/m², and especially preferably from 10 to 1,000 mg/m². If the proportion of amount of the compound semiconductor to the binder is too much or coating amount is too much, there are cases where the transmittance of all the rays of light of the film lowers, while when too little a coating amount results in lowering of conductivity, therefore, it is preferred that the coating amount is in the above range.

### Manufacturing Method:

The antistatic optical film in the invention can be obtained, for example, by preparing a solution by dissolving a compound semiconductor solubilized in the solvent and a binder soluble in the solvent, coating the obtained solution on a support or on other layer formed on a support, and then drying to evaporate the solvent and form an antistatic layer, and forming an adhesive layer and an antireflection layer according to known methods.

For coating the above solution, for example, spin coating, immersion coating, spray coating, bar coating, bead coating by a continuous coater, bar coating by a continuous coater, hopper coating by a continuous coater, and a continuously moving wick method are used, but the invention is not restricted thereto.

### Physical Characteristics and the Like:

Since the antistatic layer in the antistatic optical film of the invention aims at electrostatic prevention of the surface film, it is preferred that the surface resistance is 10¹⁰ Ω/□ or less, and the transmittance of all the rays of light is 85% or more, and more preferably the surface resistance is 10⁹ Ω/□ or less, and the transmittance of all the rays of light is 90% or more.

When the surface resistance of the antistatic layer is higher than 10¹⁰ Ω/□, the value of resistance of the outermost surface of the optical film rises. When the surface resistance is higher than 10¹² Ω/□, the antistatic performance is not sufficient and static electricity is caused and charged in peeling off a surface protective film, and there are cases where the circuit of a liquid crystal panel is broken by the static electricity. Further, when the surface resistance of the outermost surface is 10¹¹ Ω/□ or more, images are sometimes disordered, therefore the surface resistance of the antistatic layer for an optical film is preferably 10¹¹ Ω/□ or less.

In an embodiment where the antistatic optical film of the invention doubles as an antireflection film, since the antireflection film is generally provided as the outermost layer of a polarizing plate and a liquid crystal display, it is necessary to prevent adhesion of dusts and the like due to static electricity, in addition to charge prevention by peeling of a surface protective film. Accordingly, it is preferred that the position of an antistatic layer and conductivity are adjusted so that the surface resistance of the outermost surface is 10¹³ Ω/□ or less.

When the transmittance of all the rays of light is less than 85%, the optical film is insufficient in luminance, which results in reduction of contrast of images, so that it is preferred that the transmittance of all the rays of light is in the above range.

### Support:

The support for use in the invention is not especially restricted, and various supports are used. For example, polyester polymers, such as polyethylene terephthalate and polyethylene naphthalate, cellulose polymers, such as diacetyl cellulose and triacetyl cellulose, acrylic polymers, such as polymethyl methacrylate, styrene polymers, such as polystyrene and AS resins, and polycarbonate polymers are exemplified. In addition, polyethylene, polypropylene, polyolefin having a cyclic or norbornene structure, polyolefin polymers, such as ethylene-propylene copolymers, sulfone polymers, polyether sulfone polymers, polyether ketone polymers, polyphenylene sulfide polymers, vinyl alcohol polymers, vinylidene chloride polymers, vinyl butyral polymers, acrylate polymers, polyoxymethylene polymers, and epoxy polymers are exemplified.

The thickness of the support in the antistatic optical film in the invention is arbitrarily determined, but from workability and a thin layer property such as the strength and handling properties, the thickness is from 1 to 500 μm or so, and especially preferably from 1 to 300 μm.

It is also preferred that the support is not colored as far as possible. By the use of a support having a phase difference value in the thickness direction (Rth) of from −90 nm to +75 nm, the coloration of the optical film originating in the support (optical coloration) can be almost solved.

### Other Layers of Antistatic Optical Film:

In addition to the antistatic layer, the antistatic optical film of the invention can be provided with other layers. As other layers of the antistatic optical film, an antireflection layer and an adhesive layer are preferred.

The examples of preferred layer constitutions are shown below.
Support/antistatic layer/antireflection layer
Support/antistatic layer/adhesive layer
Adhesive layer/support/antistatic layer
Support/antistatic layer/antireflection layer/adhesive layer
Adhesive layer/support/antistatic layer/antireflection layer

### Adhesive Layer:

It is a preferred embodiment of the antistatic optical film of the invention to have an adhesive layer laminated on the side of the optical film surface having the antistatic layer or on the opposite side. When the optical film is adhered to a liquid crystal cell or other optical films, an adhesive is used. In such a case, it is preferred to use an adhesive type optical film having an adhesive provided in advance as an adhesive layer on one surface of the optical film for having an advantage of not necessitating a drying process for fixing the optical film.

The adhesive layer can be formed by coating an adhesive on the support, antistatic layer or antireflection layer so as to be positioned on the outermost surface of the optical film, or by sticking a release sheet having an adhesive layer formed by coating an adhesive in advance.

As adhesives that can be used in this case, acrylic adhesives, such as butyl acrylate can be used.

When the adhesive layer is provided, the thickness is preferably from 5 to 50 μm, and more preferably from 10 to 40 μm.

### Antireflection Layer:

As the antireflection layer, a low refractive index layer, a high refractive index layer and a middle refractive index layer that are ordinarily used in this kind of optical film can be used with no limitation.

Besides these layers, other layers such as a hard coat layer generally formed in optical films can also be formed in ordinary layer arrangement.

In the case where the antistatic optical film in the invention is an antireflection film having formed an antireflection layer, the antireflection film contains at least a support, an antistatic layer and an antireflection layer, and the position of the antistatic layer to be formed is not especially restricted. For example, the layer structures as disclosed in Japanese Patent No. 3507719, JP-A-10-306902, JP-A-14-333525, JP-A-2001-110238, JP-A-2003-294904 and JP-A-2005-196122 can be applied to the invention. As the support to be used, the supports described later as the transparent protective film of a polarizing plate are used.

### Polarizing Plate, Image Display, and Liquid Crystal Display:

The antistatic optical film in the invention is used for forming an image display such as a liquid crystal display, and generally a plurality of a polarizing plate, a phase difference plate, an optically compensatory film, an accuracy improving film, and an antireflection film are used by sticking according to purposes, but the kinds are not especially limited.

### Polarizing Plate:

The polarizing plate in the invention will be described below.

The polarizing plate in the invention is a polarizing plate comprising a polarizing film and protective films provided on both sides of the polarizing film, and at least one protective film is the antistatic optical film of the invention.

A polarizing plate is an essential constitutional member of a liquid crystal panel and the like.

Various kinds of polarizing films can be used without restriction. As polarizing films, for example, films obtained by adsorbing iodine and dichroic substances such as dichroic dyes onto hydrophilic polymer films such as polyvinyl alcohol films, partially formalated polyvinyl alcohol films, and ethylene-vinyl acetate copolymer partially saponified films, and monoaxially stretched, and polyene series orientation films, such as dehydration treatment products of polyvinyl alcohol and dehydrochlorination treatment products of polyvinyl chloride are exemplified. Of these films, the former films are generally used, and the thickness is from 5 to 80 μm or so.

At least one of the protective films provided on one side or both sides of the polarizing film is the antistatic optical film of the invention. When a film other than the antistatic optical film is used, as the materials for forming a protective film, those excellent in transparency, mechanical strength, heat stability, a moisture shielding property, and isotropy are preferably used. For example, polyester polymers, such as polyethylene terephthalate and polyethylene naphthalate, cellulose polymers, such as diacetyl cellulose and triacetyl cellulose, acrylic polymers, such as polymethyl methacrylate, styrene polymers, such as polystyrene and AS resins, and polycarbonate polymers are exemplified. In addition, polyethylene, polypropylene, polyolefin having a cyclic or norbornene stracture, polyolefin polymers, such as ethylene-propylene copolymers, sulfone polymers, polyether sulfone polymers, polyether ketone polymers, polyphenylene sulfide polymers, vinyl alcohol polymers, vinylidene chloride polymers, vinyl butyral polymers, acrylate polymers, polyoxymethylene polymers, and epoxy polymers are exemplified, and they are used by one kind alone or in combination of two or more to form a protective film. A transparent protective film can also be formed as cured layers of acrylic, urethane, acrylic urethane, epoxy, and silicone series thermosetting and ultraviolet curable resins.

The thickness of the protective film is arbitrarily determined, but from workability and a thin layer property such as the strength and handling properties, the thickness is generally from 1 to 500 μm or so, and especially preferably from 1 to 300 μm. It is also preferred that the protective film is not colored as far as possible. By the use of a protective film having a phase difference value in the thickness direction (Rth) of from −90 nm to +75 nm, the coloration of the polarizing plate originating in the protective film (optical coloration) can be almost solved.

As the protective film, cellulose series polymers such as triacetyl cellulose are preferably used from polarizing characteristics and durability. Triacetyl cellulose films are especially preferred. When protective films are provided on both sides of a polarizing film, protective films comprising the same polymer material may be used on the obverse and reverse, or protective films comprising different polymer materials may be used. The polarizing film and the protective film are generally adhered via an aqueous adhesive. As the aqueous adhesives, isocyanate adhesives, polyvinyl alcohol adhesives, gelatin adhesives, vinyl latexes, aqueous polyurethane and aqueous polyesters can be exemplified.

The surface of the protective film that is not adhered to the polarizing film may be subjected to treatment aiming at a hard coat layer, antireflection, sticking prevention, diffusion, or antiglare.

### Image Display, Liquid Crystal Display:

The image display and liquid crystal display in the invention will be described below.

The image display in the invention has the antistatic optical film of the invention, or the polarizing plate of the invention.

The liquid crystal display in the invention is a liquid crystal display having a liquid crystal cell of an IPS system or a VA system, and has the antistatic optical film of the invention or the polarizing plate of the invention.

That is, the antistatic optical film of the invention and the polarizing plate of the invention can be used as the surface films of the image plane of an image display such as a liquid crystal panel.

As the liquid crystal panels to be used, a VA mode of substantially vertically aligning rod-like liquid crystal molecules at the time of not applying voltage and substantially horizontally aligning at the time of applying voltage, an MVA mode of further making the VA mode multi-domains, an IPS mode of switching by applying in-plane field to nematic liquid crystal, and an OCB mode of substantially symmetrically orientating rod-like liquid crystal molecules on the upper part and the lower part of a liquid crystal cell are preferably exemplified, since these are modes wide in viewing angle. In particular, the antistatic optical film and the polarizing plate in the invention can be preferably used for a liquid crystal display having a liquid crystal cell of an IPS mode or a VA mode.

### EXAMPLE

The invention will be described specifically with reference to examples and comparative examples, but the invention is by no means restricted thereto.

Evaluations are performed as follows.

### Surface Resistance Value:

The surface resistance of the antistatic layer surface is measured with a surface resistance meter (Hiresta MCP-HT450, manufactured by Mitsubishi Chemical Corporation) on the condition of 25° C. 60% RH.

### Evaluation of Dust Removing Property:

The support side of an optical film is stuck on the monitor via an adhesive and dusts (fibrous dusts of bedding and clothes) are sprinkled over the surface of the monitor. The dusts are wiped out with cleaning cloth and a dust-removing property is examined, and evaluated according to the following three grades.
A: Dusts can be completely wiped off.
B: Dusts remain a little.
C: Dusts remain considerably.

### Electrostatic Charge Amount Due to Peeling:

### Polarizing Plate:

A formed antistatic elliptical polarizing plate is cut out in a strip of a size of 70 mm×100 mm, release sheet A (to be described below) is peeled off and the adhesive layer is stuck on a glass plate. In the next place, the surface protective film (to be described below) is peeled on the condition of 23° C. 50% RH in the direction of 180° at a constant speed of 5 m/min. The charged amount (kV) of the polarizing plate surface just after peeling is measured with a digital electrostatic potential meter (KSD-0103, manufactured by Kasuga). The peeling force of the surface protective film is 1N/25 mm or less.

### Antireflection Film:

A formed antistatic optical film having an antireflection layer is cut out in a strip of a size of 70 mm×100 mm, and the reverse surface (support side) and a glass plate is fastened with a double faced tape. A surface protective film (release sheet B: PET, thickness, 38 μm, adhesive layer: acrylic adhesive, thickness, 20 μm) is stuck on the surface of the optical film, and the film is peeled on the condition of 23° C. 50% RH in the direction of 180° at a constant speed of 5 m/min. The charged amount of the optical film surface just after peeling is measured with a digital electrostatic potential meter.

### Disorder of Image:

A liquid crystal cell of an IPS mode having an obverse glass substrate treated with ITO and a reverse glass substrate not treated with ITO is used. Release sheet A is peeled from the polarizing plate and the adhesive layer is stuck on the reverse of the liquid crystal cell to obtain a liquid crystal panel. The liquid crystal panel is put on the backlight with the stuck surface of the liquid crystal panel being upside. After that, the surface protective film on the polarizing plate surface is peeled in the direction of 180° at a constant speed of 5 m/min, and the disorder of the liquid crystal layer is confirmed. For evaluation, time required for disorder of the liquid crystal layer to be restored to the initial state is measured. The shorter the time, the higher is the performance.

### Transmittance of All the Rays of Light:

Transmittance of all the rays of light is measured with a haze meter (manufactured by Nippon Denshoku Industries Co., Ltd.).

### Examples 1 to 4, and Comparative Examples 1 and 2

An antistatic layer is formed by bar coating a coating solution comprising each of the components shown in Table 1 below in a dry coating mass of 100 mg/m² on one surface of a support comprising a monoaxially stretched norbornene resin (trade name “Arton”, manufactured by JSR Corporation) of a phase difference plate (100 μm) having been subjected to corona electrical charging, and dried at 100° C. for 5 minutes. Of the compositions, the one using a photo-polymerizable material is after that irradiated with a metal halide lamp at 500 mJ/cm² under nitrogen purge (nitrogen concentration: 0.5% or less) to harden the antistatic layer. The adhesive layer of release sheet A (a sheet having an adhesive layer formed by coating an adhesive on a PET sheet the one surface of which has been subjected to silicon releasing treatment) is stuck on the antistatic layer to obtain an antistatic optical film as an antistatic phase difference plate.

On one hand, a polarizing film is obtained by stretching a polyvinyl alcohol film having a thickness of 100 μm by 5 times in an iodine aqueous solution at 40° C., and then drying at 50° C. for 4 minutes. A triacetyl cellulose film is stuck on both sides of the polarizing film with a polyvinyl alcohol adhesive to obtain a polarizing plate.

An adhesive polarizing plate is manufactured by forming an adhesive layer having a thickness of 25 μm comprising an acrylic adhesive on one side of the polarizing plate. The adhesive layer of the adhesive polarizing plate is stuck on the other side of the antistatic phase difference plate, and further a surface protective film (release sheet B: PET, thickness, 38 μm, adhesive layer: acrylic adhesive, thickness, 20 μm) is stuck on the other side of the polarizing plate and an antistatic elliptical polarizing plate is manufactured.

With respect to the antistatic elliptical polarizing plate formed, the above described surface resistance value, electrostatic charge amount due to peeling, disorder of image, and transmittance of all the rays of light are evaluated. The results obtained are shown in Table 1 below. Incidentally, the surface resistance value is measured after forming the antistatic layer and before sticking release sheet A.

TABLE 1

| | | Irradiation with | Surface | Electrostatic | | Transmittance |
|---|---|---|---|---|---|---|
| | | Light After | Resistance | Charge Amount | | of All the |
| | | Coating And | Value | due to Peeling | Disorder of | Rays of Light |
| Example No. | Composition of solution | Drying | (Ω/□) | (kV) | Image | (%) |
| Example 1 | Cuprous iodide (3 g) | No | 5.8 × 10⁶ | 0.1 | Not longer | 93 |
| | Coronate L (manufactured by Nippon | | | | than 1 sec. | |
| | Polyurethane Industry Co., Ltd.) (0.3 g) | | | | | |
| | Acetonitrile (96.7 g) | | | | | |
| Example 2 | Cuprous iodide (1.5 g) | No | 1.2 × 10⁷ | 0.2 | Not longer | 93.4 |
| | Epoxy Resin, Epicote 828 (0.2 g) | | | | than 3 sec | |
| | Acetonitrile (98.3 g) | | | | | |
| Example 3 | Cuprous iodide (2 g) | Yes | 3.8 × 10⁶ | 0.1 | Not longer | 93.2 |
| | Pentaerythritol tetraacrylate (0.25 g) | | | | than 1 sec. | |
| | Irgacure 907 (manufactured by Ciba Geigy | | | | | |
| | Japan Limited) (0.02 g) | | | | | |
| | Acetonitrile (97.73 g) | | | | | |
| Example 4 | Cuprous iodide (2 g) | Yes | 8.5 × 10⁶ | 0.3 | Not Longer | 93.2 |
| | Vinyl Acetate Resin C-5 (manufactured by | | | | than 3 sec | |
| | Sekisui Chemical Co., Ltd.) (0.4 g) | | | | | |
| | Acetonitrile (97.6 g) | | | | | |
| Comparative | None | | 2.4 × 10¹³ | 1.6 | 30 minutes | 93.7 |
| Example 1 | | | | | or more | |
| Comparative | ATO coating solution ASHC-4 | Yes | 1.8 × 10¹⁰ | 0.5 | Not longer | 92.7 |
| Example 2 | (manufactured by Sumitomo Osaka Cement | | | | than 20 sec | |
| | Co., Ltd.) | | | | | |

ATO coating solution-ASHC-4. A solution obtained by dispersing ATO in MEK, diacetone alcohol and ethylene glycol together with a photo-curable resin (solid content: 6%) is coated in solid content of 0.2 g/m², and cured by irradiation of quantity of light of 150 mJ/cm².

### Examples 5 to 8, and Comparative Examples 3 and 4

A coating solution for a hard coat layer (HC-1) having the composition shown below is coated on a triacetyl cellulose film as a support (trade name: TAC-TD80U, manufactured by Fuji Photo Film Co., Ltd.) having a thickness of 80 μm and a width of 1,340 mm by a micro gravure coating method on the condition of a carrying speed of 30 m/min, dried at 60° C. for 150 seconds, and irradiated with a metal halide lamp at an energy quantity of 400 mJ/cm² under nitrogen purge (nitrogen concentration: 0.5% or less) to harden the coated solution to form a hard coat layer having a thickness of 6 μm.

### Coating Solution For Hard Coat Layer (HC-1):

| | |
|---|---|
| A mixture of pentaerythritol triacrylate and | 50.0 mass parts |
| pentaerythritol tetraacrylate “PETA” (manufactured by | |
| Nippon Kayaku Co., Ltd.) | |
| Polymerization initiator “Irgacure 127” (manufactured by | 2.0 mass parts |
| Ciba Geigy Japan Limited) | |
| Fluorine surfactant (polymer of hexafluoromethylene | 0.75 mass parts |
| acrylate) | |
| Toluene | 38.5 mass parts |

A solution having each of the compositions shown in Table 2 is coated on the hard coat layer by a micro gravure coating method on the condition of a carrying speed of 15 m/min, dried at 100° C. for 150 seconds to prepare an antistatic layer of a dry coating mass of 150 mg/m². Of the compositions, the one using a photo-polymerizable material is after that irradiated with a metal halide lamp at 500 mJ/cm2 under nitrogen purge (nitrogen concentration: 0.5% or less) to harden the antistatic layer.

A coating solution for low refractive index layer (Ln1) for forming an antireflection layer is coated on the antistatic layer by a micro gravure coating method on the condition of a carrying speed of 15 m/min, dried at 120° C. for 150 seconds and further at 140° C. for 8 minutes, and irradiated with an ultraviolet ray at 900 mJ/cm² under nitrogen purge (nitrogen concentration: 0.5% or less) to harden the coated layer to form a low refractive index layer (the outermost layer) having a thickness of 9.5 nm to obtain an antistatic optical film having an antireflection layer.

### Coating Solution For Low Refractive Index Layer (Ln1):

| | |
|---|---|
| Thermal crosslinking fluorine-containing polymer | 13.0 mass parts |
| “JN-7228” (solid content concentration: 6 mass %, | |
| manufactured by JSR) having a refractive index of | |
| 1.42 | |
| MEK dispersion of silica fine particles “MEK-ST-L” | 1.3 mass parts |
| (average particle size: 45 nm, solid content | |
| concentration: 30 mass %, manufactured by Nissan | |
| Chemical Industries, Ltd.) | |
| Organosilane compound “KBM-5103” | 0.6 mass parts |
| (manufactured by Shin-Etsu Chemical Co., Ltd.) | |
| Methyl ethyl ketone | 5.0 mass parts |
| Cyclohexanone | 0.6 mass parts |

With respect to the manufactured antistatic optical film having an antireflection layer, surface resistance value, a dust removing property, electrostatic charge amount due to peeling, and transmittance of all the rays of light are evaluated. The results obtained are shown in Table 2 below.

TABLE 2

| | | Irradiation with | Surface | | Electrostatic | Transmittance |
|---|---|---|---|---|---|---|
| | | Light After | Resistance | Dust | Charge Amount | of All the |
| | | Coating And | Value | Removing | due to Peeling | Rays of Light |
| Example No. | Composition of solution | Drying | (Ω/□) | Property | (kV) | (%) |
| Example 5 | Cuprous iodide (3 g) | No | 8.6 × 10⁶ | A | 0.1 | 91.8 |
| | Coronate L (manufactured by Nippon | | | | | |
| | Polyurethane Industry Co., Ltd.) (0.3 g) | | | | | |
| | Acetonitrile (96.7 g) | | | | | |
| Example 6 | Cuprous iodide (1.5 g) | No | 7.6 × 10⁶ | A | 0.1 | 92.7 |
| | Epoxy Resin, Epicote 828 (0.2 g) | | | | | |
| | Acetonitrile (98.3 g) | | | | | |
| Example 7 | Cuprous iodide (2 g) | Yes | 7.5 × 10⁶ | A | 0.1 | 91.7 |
| | Pentaerythritol tetraacrylate (0.25 g) | | | | | |
| | Irgacure 907 (manufactured by Ciba Geigy | | | | | |
| | Japan Limited) (0.02 g) | | | | | |
| | Acetonitrile (97.73 g) | | | | | |
| Example 8 | Cuprous iodide (2 g) | Yes | 8.5 × 10⁶ | A | 0.1 | 92.1 |
| | Vinyl Acetate Resin C-5 (manufactured by | | | | | |
| | Sekisui Chemical Co., Ltd.) (0.4 g) | | | | | |
| | Acetonitrile (97.6 g) | | | | | |
| Comparative | None | | 3.4 × 10¹³ | C | 1.9 | 93.3 |
| Example 3 | | | | | | |
| Comparative | ATO coating solution ASHC-4 (manufactured | Yes | 4.8 × 10¹⁰ | A | 0.7 | 90.5 |
| Example 4 | by Sumitomo Osaka Cement Co., Ltd.) | | | | | |

### Example 9

A coating solution for an antistatic layer (AS-1) having the composition shown below is coated on a triacetyl cellulose film as a support having a thickness of 50 μm and a width of 1,340 mm by a micro gravure coating method on the condition of a carrying speed of 15 m/min, and dried at 100° C. for 150 seconds to form an antistatic layer having a dry mass of 200 mg/m².

### Antistatic Composition AS-1:

| | | |
|---|---|---|
| Cuprous iodide | 3 | g |
| Millionate MR-100 (polyphenylene isocyanate | 0.5 | g |
| composition, manufactured by Nippon | | |
| Polyurethane Industry Co., Ltd.) | | |
| Acetonitrile | 96.5 | g |

A coating solution for a hard coat layer (HC-2) having the composition shown below is coated on the antistatic layer by a micro gravure coating method on the condition of a carrying speed of 30 m/min, dried at 80° C. for 150 seconds, and irradiated with a metal halide lamp at an energy quantity of 400 mJ/cm² under nitrogen purge (nitrogen concentration: 0.5% or less) to form a hard coat layer having a thickness of 5 μm.

### Coating Solution For Hard Coat Layer (HC-2):

| | | |
|---|---|---|
| PET-30 (a mixture of pentaerythritol | 50 | g |
| triacrylate and pentaerythritol | | |
| tetraacrylate (manufactured by | | |
| Nippon Kayaku Co., Ltd.) | | |
| Methyl isobutyl ketone | 28.5 | g |
| Methyl ethyl ketone | 7.0 | g |
| Irgacure 184 (a polymerization initiator, | 2.0 | g |
| manufactured by Ciba Geigy Japan Limited) | | |
| SX-500H (30%) (crosslinked polystyrene | 14.5 | g |
| particles having an average particle size | | |
| of 5 μm, refractive index: 1.60, a 30% methyl | | |
| isobutyl ketone dispersion, dispersed with | | |
| POLYTRON disperser at 10,000 rpm for 20 minutes | | |
| before use, manufactured by The Soken Chemical | | |
| & Engineering Co., Ltd.) | | |
| FP-132 (a fluorine surface modifier, | 0.75 | g |
| a polymer containing fluoro resin represented | | |
| by the following formula disclosed in | | |
| JP-A-2005-316422, paragraph [0207]) | | |
| KBM-5103 (manufactured by Shin-Etsu Chemical | 3.0 | g |
| Co., Ltd.) | | |

A low refractive index coating solution (Ln2) is coated on the hard coat layer by a micro gravure coating method on the condition of a carrying speed of 15 m/min, dried at 10° C. for 150 seconds and further at 120° C. for 8 minutes under nitrogen purge, and irradiated with an ultraviolet ray at 600 mJ/cm² to harden the coated layer to form a low refractive index layer (the outermost layer) having a thickness of 10 nm to obtain an antistatic optical film having an antireflection layer.

### Coating Solution For Low Refractive Index Layer (Ln2):

### Preparation of Dispersion B1 of Particles Having Vacancies Inside:

Silica fine particles having vacancies inside are formed by changing the conditions in preparation in Preparation Example 4 disclosed in JP-A-2002-79616. In the final step, solvent substitution is performed from the aqueous dispersion state to methanol to make 20% silica dispersion and obtain particles having an average particle size of 45 mn, a shell thickness of about 7 nm, and the refractive index of silica particles of 1.30. To 500 g of the dispersion, 30 g of acryloyloxypropyltrimethoxysilane and 1.5 g of diisopropoxyaluminum ethyl acetate are added and mixed, and then 9 parts of ion exchange water is added thereto. After being allowed to react at 60° C. for 8 hours, the reaction solution is cooled to room temperature, and 1.8 g of acetylacetone is added. Substitution is performed by distillation under reduced pressure while adding MEK so that the total amount of the liquid becomes almost constant. Finally, the solid content is adjusted to 20% to prepare dispersion B1.

### Composition of Coating Solution:

| | |
|---|---|
| Fluorine copolymer P-3 (mass average | 39.0 g |
| molecular weight: about 50,000, | |
| disclosed in JP-A-2004-45462) | |
| Dipentaerythritol hexaacrylate | 5.0 g |
| RMS033 (a silicone compound, manufactured | 3.0 g |
| by Shin-Etsu Chemical Co., Ltd.) | |
| Irgacure 907 (a polymerization initiator, | 3.0 g |
| manufactured by Ciba Geigy Japan Limited) | |
| Above dispersion B1 | 50 g |

With respect to the manufactured antistatic optical film having an antireflection layer, the characteristics are evaluated in the same manner as above. The surface resistance value is 3.2×10⁷ Ω/□, dust removing property is graded A, electrostatic charge amount due to peeling is 0.1 kV, and transmittance of all the rays of light is 93.2%.

### Example 10

For examining the mechanical durability of antistatic layers, the films in Examples 5 to 8, Example 9, and Comparative Example 4 are formed up to the stage of the antistatic layers and scratch resistance against steel wool of each film is evaluated on the following conditions.

Instrument: rubbing tester

### Conditions:

Atmospheric condition: 25° C. 60% RH

Rubbing material: steel wool (Gelete N0.0000, manufactured by Nihon Steel Wool Co., Ltd.)

Steel wool is wound round rubbing tip (1 cm×1 cm) that is in contact with a sample and fixed with a band.

Moving distance (one way): 13 cm

Load: 300 g/cm²

Number of times: 10 times of going to and from

After that, the reverse side of a sample is painted with black oil ink, visually observed by reflected light, and judged by the following criteria.
A: A scratch is not seen at all.
B: Weak scratches are faintly seen.
C: Weak scratches are seen.
D: Serious scratches are seen.

### Results:

Antistatic layer in Example 5: A
Antistatic layer in Example 6: A
Antistatic layer in Example 7: B
Antistatic layer in Example 8: C
Antistatic layer in Example 9: A
Antistatic layer in Comparative Example 4: D

### Example 11

For examining the weather resistance of antistatic layers, the films in Examples 5 to 8, Example 9, and Comparative Example 4 are formed up to the stage of the antistatic layers, and their surface resistance is measured after they are allowed to stand on condition of 70° C. 50% RH for one week. The weather resistance is judged by the following criteria as compared with the surface resistance before being allowed to stand.
A: The variation of surface resistance is by 5 times or less.
B: The variation of surface resistance is by 5 to 10 times.
C: The variation of surface resistance is by 10 to 100 times.
D: The variation of surface resistance is by 100 times or more.

### Results:

Antistatic layer in Example 5: A
Antistatic layer in Example 6: B
Antistatic layer in Example 7: B
Antistatic layer in Example 8: C
Antistatic layer in Example 9: A
Antistatic layer in Comparative Example 4: D

From the results shown in Tables 1 and 2, and in Example 9, it is apparent that the antistatic optical films in the invention are low in surface resistance, small in electrostatic charge amount due to peeling, excellent in a dust removing property, and high in transmittance of all the rays of light (that is, transparency is good). Further, it can be seen from Examples 10 and 11 that the antistatic optical films in the invention are excellent in mechanical strength and weather resistance.

An antistatic layer excellent in an antistatic property, optical characteristics, durability and appearance can be provided according to the invention by a simple process such as a coating method inexpensively and easily, and an antistatic optical film excellent in productivity can be provided. Further, by containing a binder soluble in a solvent capable of dissolving a compound semiconductor in a solution for forming the antistatic layer, the antistatic optical film in the invention 1) is capable of adjusting the amount of fine particles of the compound semiconductor without necessitating complicated operation, and 2) fixes the fine particles of the compound semiconductor formed and has an effect of preventing flocculation of the compound semiconductor fine particles with the lapse of time.

In particular, when the compound semiconductor is cuprous halide, the antistatic optical film can be manufactured inexpensively and in a large quantity.

Further, an image display (especially a liquid crystal display) having the antistatic optical film excellent in an antistatic property, optical characteristics, durability and appearance can be provided according to the invention.

The entire disclosure of each and every foreign patent application from which the benefit of foreign priority has been claimed in the present application is incorporated herein by reference, as if fully set forth.

What is claimed is:

1. An antistatic optical film comprising:
a support; and
an antistatic layer provided at least on one side of the support, wherein
the antistatic layer is a layer formed by coating a solution containing a compound semiconductor, a solvent capable of dissolving the compound semiconductor; and a binder soluble in the solvent; and drying the solution.

2. The antistatic optical film of claim 1, wherein
the compound semiconductor is cuprous halide.

3. The antistatic optical film of claim 1, wherein
the binder is a curable resin.

4. The antistatic optical film of claim 13 wherein
the antistatic layer has a surface resistance of 10¹⁰ Ω/□ or less, and has a transmittance of all the rays of light of 85% or more.

5. The antistatic optical film of claim 1, further comprising:
an adhesive layer.

6. The antistatic optical film of claim 1, further comprising:
an antireflection layer.

7. A polarizing plate comprising:
a polarizing film; and
protective films provided on both sides of the polarizing film, wherein
at least one of the protective films is the antistatic optical film of claim 1.

8. An image display comprising:
the antistatic optical film of claim 1.

9. An image display comprising:
the polarizing plate of claim 7.

10. A liquid crystal display comprising:
an IPS mode or VA mode liquid crystal cell; and
the antistatic optical film of claim 1.

11. A liquid crystal display comprising:
an IPS mode or VA mode liquid crystal cell; and
the polarizing plate of claim 7.
